(19) United States
(12) Patent Application Publication
(10) Pub. No.: US 2025/0136120 A1
(43) Pub. Date: May 1, 2025

(54) DRIVING ASSISTANCE DEVICE, DRIVING ASSISTANCE METHOD, AND DRIVING ASSISTANCE SYSTEM

(71) Applicant: Panasonic Automotive Systems Co., Ltd., Kanagawa (JP)

(72) Inventors: Koichi EMURA, Kanagawa Ken (JP); Masataka KATO, Kanagawa Ken (JP)

(73) Assignee: Panasonic Automotive Systems Co., Ltd., Kanagawa (JP)

(21) Appl. No.: 18/929,036

(22) Filed: Oct. 28, 2024

(30) Foreign Application Priority Data
Oct. 31, 2023 (JP) 2023-186280

(51) Int. Cl. B60W 40/09; B60W 30/182; B60W 40/08; B60W 50/14; G06V 20/56

(52) U.S. Cl. CPC B60W 40/09; B60W 30/182; B60W 50/14; G06V 20/56; B60W 2040/0818; B60W 2420/403; B60W 2520/06; B60W 2540/229

(57) ABSTRACT

A driving assistance device according to the present disclosure includes a processor and a memory having instructions that, when executed by the processor, cause the processor to perform operations including: determining whether a traveling direction of a vehicle is a predetermined direction; calculating a feature amount of a predetermined region which is included in each of photographed images in the predetermined direction of the vehicle and in which a frequency at which the feature amount is equal to or larger than a threshold is equal to or higher than a predetermined frequency when the traveling direction of the vehicle is the predetermined direction; and estimating an attention state of a driver of the vehicle from the feature amount.

### CROSS-REFERENCE TO RELATED APPLICATIONS

This application is based upon and claims the benefit of priority from Japanese Patent Application No. 2023-186280, filed Oct. 31, 2023, the entire contents of which are incorporated herein by reference.

### FIELD

Embodiments described herein relate generally to a driving assistance device, a driving assistance method, and a driving assistance system.

### BACKGROUND

There has been known a system that estimates an attention state indicating a degree of inappropriateness of a driver for driving due to generation of an abnormal state such as a functional disorder or a disease of the driver. For example, there is disclosed a system that determines an attention state of a driver according to a correlation between a high salient region included in a photographed front-side image of a vehicle and an amplitude of a saccade of the driver. Conventional technologies are described in Japanese Patent Application Laid-open No. 2021-77140, for example.

However, the high salient region included in the photographed front-side image during driving tends to concentrate on a vanishing point where a line of sight of a driver in a field of view of the driver during driving is naturally guided, and a neighboring region of the vanishing point including the vanishing point. Thus, there is a problem that estimation accuracy is low in the estimation of an attention state using the salient region. That is, in the existing technology, there is a case where the estimation accuracy of the attention state of the driver decreases. In addition, even in a healthy state and not in an abnormal state such as a functional disorder or a disease, the driver may fall into an inappropriate state for driving, such as distraction.

An object of the present disclosure is to provide a driving assistance device, a driving assistance method, and a driving assistance system, which are capable of estimating an attention state of a driver and improving estimation accuracy even in a healthy state.

### SUMMARY

A driving assistance device according to an embodiment of the present disclosure includes a processor and a memory having instructions that, when executed by the processor, cause the processor to perform operations including: determining whether a traveling direction of a vehicle is a predetermined direction; calculating a feature amount of a predetermined region which is included in each of photographed images in the predetermined direction of the vehicle and in which a frequency at which the feature amount is equal to or larger than a threshold is equal to or higher than a predetermined frequency when the traveling direction of the vehicle is the predetermined direction; and estimating an attention state of a driver of the vehicle from the feature amount.

### BRIEF DESCRIPTION OF THE DRAWINGS

FIG. 1 is a diagram illustrating an example of a driving assistance system according to an embodiment;

FIG. 2 is a schematic diagram illustrating an example of an installation position of a photographing unit;

FIG. 3 is a hardware configuration diagram of a driving assistance device;

FIG. 4 is a block diagram illustrating an example of a functional configuration of a driving assistance system;

FIG. 5 is a diagram explaining a region included in a photographed image;

FIG. 6A is a diagram explaining an example of an output mode of when an attention state is good;

FIG. 6B is a diagram explaining an example of an output mode of when the attention state is poor; and

FIG. 7 is a flowchart illustrating an example of a flow of information processing.

### DETAILED DESCRIPTION

Hereinafter, embodiments of a driving assistance device, a driving assistance method, and a driving assistance system according to the present disclosure will be described with reference to the accompanying drawings.

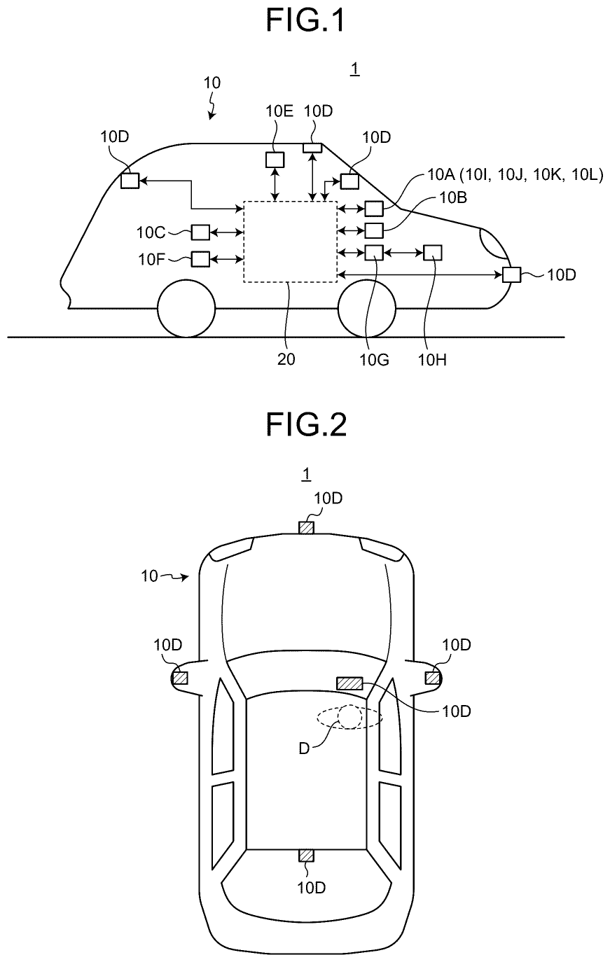

FIG. 1 is a diagram illustrating an example of a driving assistance system 1 of the present embodiment.

The driving assistance system 1 includes a vehicle 10.

The vehicle 10 includes a driving assistance device 20, an output unit 10A, an input unit 10B, an internal sensor 10C, a photographing unit 10D, a communication unit 10E, an electronic control unit (ECU) 10F, a drive control unit 10G, and a drive unit 10H.

The driving assistance device 20 is, for example, a dedicated or general-purpose computer. In the present embodiment, a form in which the driving assistance device 20 is mounted on the vehicle 10 will be described as an example.

The vehicle 10 is a movable object. In the present embodiment, the vehicle 10 is an object that the user can get on. The vehicle 10 is, for example, a two-wheeled automobile, a three-wheeled automobile, or a four-wheeled automobile. Furthermore, the vehicle 10 is, for example, a vehicle that travels through driving operation by a person, or a vehicle that can automatically travel (automatically travel) without through the driving operation by the person.

The output unit 10A and the input unit 10B function as human-machine interfaces (HMI) that output information to a user such as an occupant of the vehicle 10 and receive an input of information from the user.

The output unit 10A outputs information. In the present embodiment, the output unit 10A outputs information generated by the driving assistance device 20. Details of the output information will be described later.

The output unit 10A may further include a display function of displaying an image representing information, a sound output function of outputting a sound representing information, a function of turning on or blinking light representing information, and the like. For example, the output unit 10A includes at least one of a display unit 10I, an illumination unit 10J, a head up display (HUD) 10K, or a speaker 10L. In the present embodiment, a form in which the output unit 10A includes the display unit 10I, the illumination unit 10J, the HUD 10K, and the speaker 10L will be described as an example.

The display unit 10I is, for example, a known organic electro luminescence (EL) display, liquid crystal display, projection device, or the like. In the present embodiment, the display unit 10I includes a center display 10Ia, a pillar display 10Ib, and a mirror display 10Ic. The center display 10Ia is a display provided in a center console in the vehicle 10. The pillar display 10Ib is a display provided in a pillar portion in the vehicle 10. The mirror display 10Ic is a display provided on a mirror such as a rearview mirror or a side mirror provided in the vehicle 10.

The illumination unit 10J is an illumination provided in the vehicle 10, and includes a light such as one or a plurality of light emitting diodes (LED). Light can be turned on or blinked in a plurality of kinds of colors. The HUD 10K is a system that directly displays information in a field of view of a driver of the vehicle 10, and projects the information on a windshield of the vehicle 10 or a projection plate (combiner) installed in the vehicle 10.

The speaker 10L outputs an audio.

An installation position of the output unit 10A may be any position as long as the driver of the vehicle 10 can check the information output from the output unit 10A.

The input unit 10B receives an input of an instruction or information from the user. The input unit 10B is, for example, at least one of an instruction input device that receives an input by operation input by the user, or a microphone that receives an audio input. The instruction input device is, for example, a button, a pointing device such as a mouse or a trackball, or a keyboard. The instruction input device may be an input function in a touch panel provided integrally with the display unit 10I.

The internal sensor 10C is a sensor that observes information of the vehicle 10. The internal sensor 10C detects a position of the vehicle 10, a speed of the vehicle 10, acceleration of the vehicle 10, a traveling direction of the vehicle 10, a steering angle of the vehicle 10, an accelerator depression amount of the vehicle 10, a brake depression amount of the vehicle 10, and the like.

The internal sensor 10C includes, for example, an inertial measurement unit (IMU), a speed sensor, a global positioning system (GPS), or the like.

The photographing unit 10D photographs a periphery of the vehicle 10 and acquires photographed image data of the periphery. Hereinafter, the photographed image data will be simply referred to as a photographed image. The periphery of the vehicle 10 is a region within a predetermined range from the vehicle 10. This range is a range that can be photographed by the photographing unit 10D. This range may be set in advance. The photographing unit 10D photographs a plurality of photographed images in time series, and sequentially outputs the photographed images to the driving assistance device 20. That is, the photographing unit 10D outputs a photographed video including a plurality of frames (photographed images) in time series to the driving assistance device 20.

The photographing unit 10D is a digital camera, a stereo camera, or the like. An installation position and an angle of view of the photographing unit 10D are adjusted in advance in such a manner that the periphery of the vehicle 10 can be photographed. In the present embodiment, the vehicle 10 includes a plurality of photographing units 10D having different photographing directions.

FIG. 2 is a schematic diagram illustrating an example of installation positions of the photographing units 10D. For example, the vehicle 10 includes the four photographing units 10D. Note that the number of photographing units 10D provided in the vehicle 10 is not limited to four. The photographing units 10D may be arranged at positions where at least a predetermined direction of the vehicle 10 can be photographed. For example, the installation positions and the number of the photographing units 10D may be adjusted in such a manner that a photographed image in a direction of substantially the entire region (such as 360 degrees) centered on the vehicle 10 on a horizontal plane is acquired. The predetermined direction will be described later.

Returning to FIG. 1, the description will be continued.

The communication unit 10E is a communication function unit to communicate with an external device of the vehicle 10 via a network or the like. The ECU 10F is an electronic control unit to control each unit of the vehicle 10.

The drive unit 10H is a drive device mounted on the vehicle 10. The drive unit 10H is, for example, an engine, a motor, a wheel, a control mechanism thereof, and the like.

The drive control unit 10G controls the drive unit 10H. The drive unit 10H is driven under control of the drive control unit 10G. For example, in order to automatically drive the vehicle 10, the drive control unit 10G controls the drive unit 10H on the basis of information acquired from the internal sensor 10C or the photographing unit 10D, information received from the driving assistance device 20, or the like. An accelerator amount, a brake amount, a steering angle, and the like of the vehicle 10 are controlled by the control of the drive unit 10H. For example, the drive control unit 10G controls the vehicle 10 in such a manner as to stop or travel according to the information received from the driving assistance device 20.

Next, a hardware configuration of the driving assistance device 20 will be described.

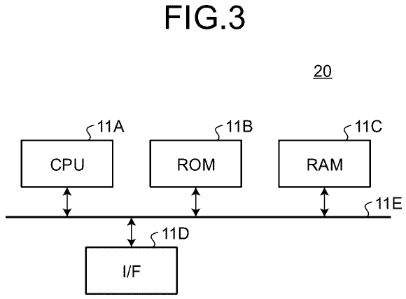

FIG. 3 is a hardware configuration diagram of the driving assistance device 20.

The driving assistance device 20 has a hardware configuration in which a normal computer is used and a central processor (CPU) 11A, a read only memory (ROM) 11B, a random access memory (RAM) 11C, an I/F 11D, and the like are connected to each another by a bus 11E.

The CPU 11A is an arithmetic device that controls the driving assistance device 20 of the present embodiment. The ROM 11B stores a program or the like that realizes processing by the CPU 11A. The RAM 11C stores data necessary for processing by the CPU 11A. The I/F 11D is an interface to transmit and receive data.

A program to execute information processing executed by the driving assistance device 20 of the present embodiment is provided by being incorporated in the ROM 11B or the like in advance. Note that the program executed by the driving assistance device 20 of the present embodiment may be configured to be stored in a computer-readable storage medium (such as flash memory) as a file in a format installable or executable in the driving assistance device 20 and provided.

Next, a functional configuration of the driving assistance system 1 will be described.

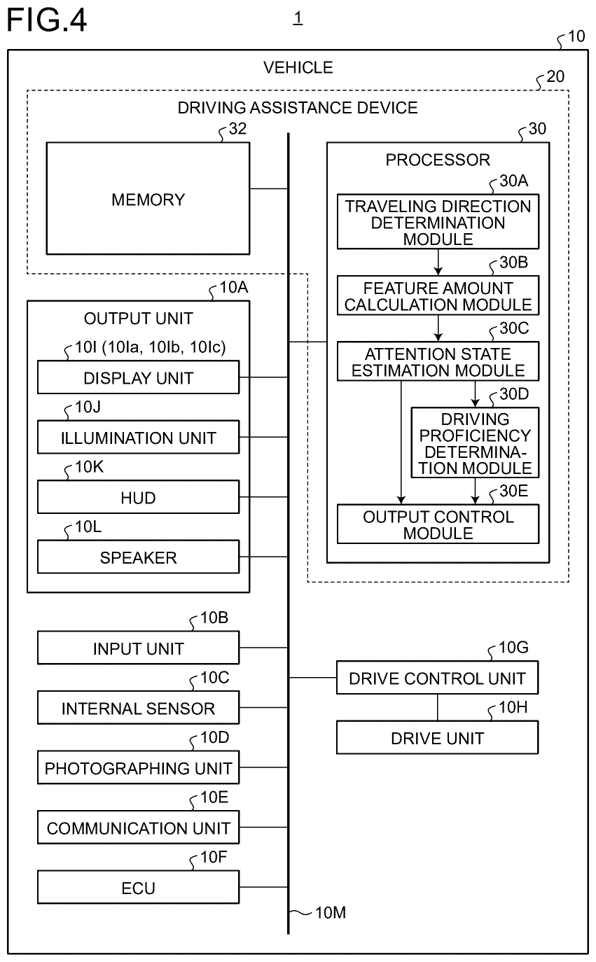

FIG. 4 is a block diagram illustrating an example of a functional configuration of the driving assistance system 1.

The vehicle 10 includes the driving assistance device 20, the output unit 10A, the input unit 10B, the internal sensor 10C, the photographing unit 10D, the communication unit 10E, the ECU 10F, the drive control unit 10G, and the drive unit 10H.

The driving assistance device 20, the output unit 10A, the input unit 10B, the internal sensor 10C, the photographing unit 10D, the communication unit 10E, the ECU 10F, and the drive control unit 10G are connected via a bus 10M or the like in such a manner as to be able to exchange data or signals. The drive control unit 10G is connected to the drive unit 10H in such a manner as to be able to exchange data or signals.

The driving assistance device 20 includes a memory 32 and a processor 30. The processor 30 and the memory 32 are connected via a bus 10M or the like in such a manner as to be able to exchange data or signals. In addition, the output unit 10A, the input unit 10B, the internal sensor 10C, the photographing unit 10D, the communication unit 10E, the ECU 10F, the drive control unit 10G, and the processor 30 are connected via the bus 10M or the like in such a manner that data or signals can be transmitted and received.

Note that at least one of the memory 32, the output unit 10A (display unit 10I (center display 10Ia, pillar display 10Ib, or mirror display 10Ic), illumination unit 10J, HUD 10K, or speaker 10L), the input unit 10B, the internal sensor 10C, the photographing unit 10D, the communication unit 10E, the ECU 10F, or the drive control unit 10G may be connected to the processor 30 in a wired or wireless manner. In addition, at least one of the memory 32, the output unit 10A (display unit 10I (center display 10Ia, pillar display 10Ib, or mirror display 10Ic), illumination unit 10J, HUD 10K, or speaker 10L), the input unit 10B, the internal sensor 10C, the photographing unit 10D, the communication unit 10E, the ECU 10F, or the drive control unit 10G may be connected to the processor 30 via the network.

The memory 32 stores data. The memory 32 is, for example, a random access memory (RAM), a semiconductor memory element such as a flash memory, a hard disk, an optical disk, or the like. Note that the memory 32 may be a storage device provided outside the driving assistance device 20. Furthermore, the memory 32 may store or temporarily store a program or information downloaded via a local area network (LAN), the Internet, or the like. Furthermore, the memory 32 may include a plurality of storage media.

The processor 30 executes information processing in the driving assistance device 20. The processor 30 includes a traveling direction determination module 30A, a feature amount calculation module 30B, an attention state estimation module 30C, a driving proficiency determination module 30D, and an output control module 30E.

The traveling direction determination module 30A, the feature amount calculation module 30B, the attention state estimation module 30C, the driving proficiency determination module 30D, and the output control module 30E are realized by, for example, one or a plurality of processors. For example, it is possible to realize each of the above units by causing a processor such as a CPU to execute a program, that is, by software. Each of the above units may be realized by a processor such as a dedicated integrated circuit (IC), that is, hardware. Each of the above units may be realized by utilization of software and hardware in combination. In a case where a plurality of processors is used, each of the plurality of processors may realize one of the plurality of units, or may realize two or more of the plurality of units.

The processor reads and executes the program stored in the memory 32, and realizes each of the plurality of units. Note that instead of storing the program in the memory 32, the program may be directly incorporated in a circuit of the processor. In this case, the processor realizes each of the plurality of units by reading and executing the program incorporated in the circuit.

The traveling direction determination module 30A determines whether a traveling direction of the vehicle 10 is a predetermined direction.

The traveling direction determination module 30A acquires the traveling direction of the vehicle 10 observed by the internal sensor 10C. In addition, the traveling direction determination module 30A may acquire the traveling direction of the vehicle 10 on the basis of an observation result of the steering angle which result is included in the internal sensor 10C. In addition, the traveling direction determination module 30A may acquire the traveling direction of the vehicle 10 from the ECU 10F that controls the vehicle 10, or may perform determination from the image photographed by the photographing unit 10D.

The traveling direction determination module 30A determines whether the acquired traveling direction of the vehicle 10 is the predetermined direction.

The predetermined direction is a direction corresponding to a specific region included in the photographed image photographed by the photographing unit 10D. In addition, the predetermined direction is a direction in which the vehicle 10 can travel.

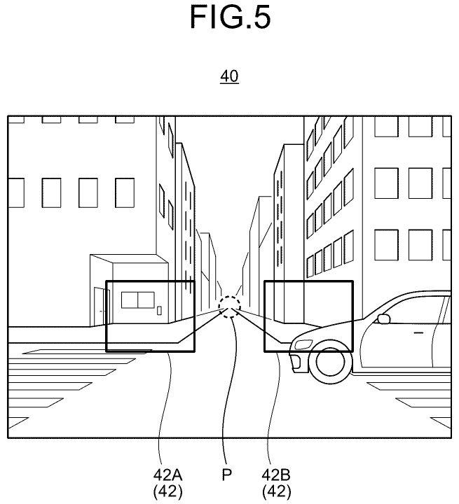

FIG. 5 is a diagram explaining a region 42 included in a photographed image 40.

The region 42 is a predetermined region which is included in the photographed image 40 of the vehicle 10 in the predetermined direction, and in which a frequency at which a feature amount becomes equal to or larger than a threshold is equal to or higher than a predetermined frequency when the traveling direction of the vehicle 10 is the predetermined direction. That is, there is a correlation among the region 42, the specific predetermined direction that is the traveling direction corresponding to the region 42, and the photographed image 40 in the predetermined direction in a point that the frequency at which the feature amount of the region 42 becomes equal to or larger than the threshold is equal to or higher than the predetermined frequency, and the predetermined direction and the photographing direction of the photographed image 40 coincide or overlap with each other. In addition, the region 42 is a region that is included in the photographed image 40 and that does not overlap with a vanishing point P where a line of sight of the driver in a field of view of the driver D during driving is naturally guided.

The photographed image 40 in the predetermined direction is a photographed image of a landscape in the predetermined direction starting from the vehicle 10 in one or a plurality of the photographed images 40 around the vehicle 10. That is, in a case where the predetermined direction is a straight direction, the photographed image 40 in the straight direction is a photographed image including a field of view of when the driver D of the vehicle 10 traveling in the straight traveling direction visually recognizes the straight direction. In other words, in a case where the predetermined direction is the straight direction, the photographed image 40 in the straight direction is the photographed image 40 photographed by the photographing unit 10D that is a front camera that photographs the straight direction of the vehicle 10.

The frequency represents a generation frequency of a predetermined condition generated in a plurality of the photographed images 40 continuously photographed in time series. In the present embodiment, the predetermined condition indicates that the feature amount is equal to or larger than the threshold. Thus, the frequency at which the feature amount of the region 42 becomes equal to or larger than the threshold represents the number of times the feature amount of the region 42 becomes equal to or larger than the threshold in the plurality of photographed images 40, which is continuous in time series and photographed within the predetermined period, per predetermined period. The plurality of photographed images 40 continuously photographed in time series and the plurality of photographed images 40 continuous in time series mean the plurality of photographed images 40 continuously photographed in time series at different photographing timing.

Values of these predetermined frequency and threshold may be set in advance, or values acquired by multiplication of a frequency of the entire feature amount or a designated distribution by a certain ratio or the like may be set. For example, as the values of the predetermined frequency and the threshold, values with which the degree of inappropriateness of the driver D for driving can be determined may be set in advance. In addition, the values of the predetermined frequency and the threshold may be appropriately changed by an operation instruction or the like of the input unit 10B by the user.

The feature amount is a characteristic value of the region 42 which value is represented by a pixel value included in the region 42 included in the photographed images 40. Specifically, the feature amount represents a change in a prediction error, an inter-frame error, variance of the prediction error, a differential of the prediction error, variance of the inter-frame error, a differential of the inter-frame error, or the like. A calculation method of the feature amount will be described later.

The feature amount being equal to or larger than the threshold means that the prediction error or the inter-frame error is equal to or larger than the threshold. Thus, it can be said that the region 42 in which the feature amount is equal to or larger than the threshold is a region in which the driver D is highly likely to unconsciously bias attention at a point other than the vanishing point P during traveling and to cause a cognitive error.

For example, description will be made with a case where the predetermined direction is the straight direction of the vehicle 10 being assumed. In this case, the photographed images 40 used to specify the region 42 are the photographed images 40 in the straight direction of the vehicle 10 which images are photographed by the photographing unit 10D that photographs a front side of the vehicle 10. In other words, the photographed images 40 in the straight direction of the vehicle 10 are photographed front-side images of the vehicle 10. Furthermore, in this case, the region 42 is a region in which the frequency, at which the feature amount becomes equal to or larger than the threshold during traveling in the straight direction, is equal to or higher than a predetermined frequency and which is included in the plurality of photographed images 40 in the straight direction, the images being continuously photographed in time series.

The photographing unit 10D continuously photographs the periphery of the vehicle 10 in time series, and sequentially outputs the photographed images 40 acquired by the photographing to the driving assistance device 20. The region 42 is a region in which the frequency at which the feature amount is equal to or larger than the threshold is equal to or higher than the predetermined frequency in the photographed images 40 in the straight direction which images are photographed in time series when the vehicle 10 is traveling in the straight direction.

In a case where the vehicle 10 is traveling in the straight direction, regions which are included in the photographed images 40 in the straight direction of the vehicle 10 and in which the frequency at which the feature amount is equal to or larger than the threshold is equal to or higher than the predetermined frequency are two regions 42A and 42B with point symmetry centered on the vanishing point P, to which the line of sight of the driver D is naturally guided, in the photographed images 40 in the straight direction which images are continuous in time series, as illustrated in FIG. 5. The region 42A and the region 42B are regions that do not overlap with the vanishing point P.

In each of a plurality of kinds of predetermined directions that are different from each other and are the traveling directions of the vehicle 10, the processor 30 previously specifies the region 42 which is included in the photographed images 40 in the predetermined direction and in which the frequency at which the feature amount becomes equal to or larger than the threshold is equal to or higher than the predetermined frequency when the traveling direction of the vehicle 10 is the predetermined direction. The processor 30 may use a known simulation technology, a learning model, or the like to specify the region 42 in each of the plurality of kinds of predetermined directions. In addition, the region 42 in each of the plurality of kinds of predetermined directions may be specified by an external device communicably connected to the driving assistance device 20 via the network or the like.

Note that the number, size, and position of the regions 42 which are included in the photographed images 40 in the predetermined direction and in which the frequency at which the feature amount becomes equal to or larger than the threshold is equal to or higher than the predetermined frequency when the traveling direction of the vehicle 10 is the predetermined direction are not limited. In a case where a plurality of the regions 42 is included in the photographed images 40, at least a part of the plurality of regions 42 may be a non-overlapping region.

The values of the threshold and the predetermined frequency used to derive the region 42 may be determined in advance. For example, with respect to the region 42 corresponding to any of the predetermined directions, the values of the threshold and the predetermined frequency may be adjusted in advance in such a manner that the region 42 that does not overlap with the vanishing point P is specified. Furthermore, the values of the threshold and the predetermined frequency used to derive the region 42 may be appropriately changed according to an operation instruction or the like of the input unit 10B by the user.

Then, it is assumed that the memory 32 of the driving assistance device 20 previously stores information indicating the corresponding region 42 that satisfies the above condition in each of the plurality of kinds of predetermined directions. Specifically, the information indicating the region 42 is information indicating a position, size, range, and the like in the photographed images 40 in the corresponding kind of predetermined direction. For example, in the predetermined direction “straight direction”, information indicating the position, size, and range of each of the region 42A and the region 42B illustrated in FIG. 5 is stored in advance in the memory 32 in association.

Returning to FIG. 4, the description will be continued.

The traveling direction determination module 30A determines whether the acquired traveling direction of the vehicle 10 coincides with any of the plurality of kinds of predetermined directions stored in the memory 32, and determines whether the traveling direction of the vehicle 10 is the predetermined direction.

For example, it is assumed that the “straight direction” as the predetermined direction and information indicating the region 42 corresponding to the straight direction are stored in the memory 32 in association with each other. In this case, the traveling direction determination module 30A determines whether the traveling direction of the vehicle 10 is the predetermined direction by determining whether the acquired traveling direction of the vehicle 10 is the straight direction.

The feature amount calculation module 30B calculates the feature amount of the region 42 which is included in the photographed images 40 in the predetermined direction of the vehicle 10 and in which the frequency at which the feature amount becomes equal to or larger than the threshold is equal to or higher than the predetermined frequency when the traveling direction of the vehicle 10 is the predetermined direction.

The feature amount calculation module 30B reads, from the memory 32, information of the region 42 corresponding to the predetermined direction determined to coincide with the traveling direction by the traveling direction determination module 30A. Then, the feature amount calculation module 30B calculates the feature amount of the region 42 of the position, size, and range indicated by the information of the region 42 included in the photographed images 40 in the predetermined direction.

For example, a case where the traveling direction determination module 30A determines that the traveling direction of the vehicle 10 is the straight direction that is the predetermined direction is assumed. In this case, the feature amount calculation module 30B specifies the region 42 which is included in the photographed images 40 in the straight direction of the vehicle 10 and in which the frequency at which the feature amount becomes equal to or larger than the threshold is equal to or higher than the predetermined frequency during traveling in the straight direction. The feature amount calculation module 30B specifies the region 42 by specifying, from the photographed images 40 in the straight direction, the region 42 of the position, the size, and the range indicated by the information of the region 42 corresponding to the predetermined direction “straight direction” in the memory 32. Specifically, the feature amount calculation module 30B specifies the region 42A and the region 42B illustrated in FIG. 5 from the photographed images 40 in the straight direction.

Then, the feature amount calculation module 30B calculates the feature amount of the specified regions 42 (region 42A and region 42B).

As described above, the feature amount represents the change in the prediction error, the inter-frame error, the variance of the prediction error, the differential of the prediction error, the variance of the inter-frame error, the differential of the inter-frame error, or the like.

The prediction error represents a difference between an actual photographed image 40 photographed at certain timing and a prediction image predicted to be photographed at the timing. A relationship between the photographed image 40 and the prediction image is that the prediction image is an image predicted to be photographed from the same photographing position as the photographed image 40 at the same photographing angle of view and at the same timing while the photographed image 40 is an actually-photographed image. That is, the photographed image 40 and the prediction image are different only in a point of being the actually-photographed image or the predicted image.

The prediction error is represented by a difference in pixel values between the photographed image 40 and the prediction image. The prediction error that is the feature amount of each of the regions 42 is represented by a difference between a representative value of the pixel value of the region 42 in the photographed image 40 and a representative value of the pixel value of the region 42 in the prediction image. The representative value may be any of an average value, a median, a maximum value, or a minimum value of pixel values of pixels included in the region 42, or a variance value or a differential value of the same pixel value arranged in time series.

A calculation method of the prediction image is not limited. For example, the traveling direction determination module 30A calculates a prediction image at calculation target timing by using a learning model of calculating a prediction image at the calculation target timing from the plurality of photographed images 40 continuously photographed in time series at timing before the calculation target timing. In addition, the traveling direction determination module 30A may calculate the prediction image at the calculation target timing by linearly changing each pixel value of the plurality of photographed images 40 continuously photographed in time series at the timing before the calculation target timing.

The inter-frame error represents an error between the photographed images 40 that are the actual photographed image 40 photographed at certain timing and the actual photographed image 40 photographed at timing different from the timing. Other conditions such as a photographing angle of view and a photographing position of these two photographed images 40 coincide with each other except that the photographing timing is different.

The inter-frame error is represented by a difference between pixel values of the two photographed images 40 at the different photographing timing. The inter-frame error that is the feature amount of each of the regions 42 is represented by a difference between representative values of the pixel values of the region 42 included in these two photographed images 40. The representative values are the same as the above.

The feature amount calculation module 30B calculates the feature amounts of the specified regions 42 (region 42A and region 42B) included in the photographed images 40.

It is meant that the value of the error between each of the regions 42 in the actual photographed image 40 and the region 42 in the prediction image is larger as the value of the prediction error represented by the feature amount is larger. That is, it is represented that the difference (error) between the pixel value of the predicted region 42 and the pixel value of the actual region 42 is large. Thus, it is represented that the driver D more easily pays attention to the region 42 as the value of the prediction error represented by the feature amount of the region 42 is larger and the frequency at which the prediction error is equal to or larger than the threshold is higher.

Similarly, it is meant that the difference between the pixel values at different photographing timing in each of the regions 42 in the photographed images 40 is larger as the value of the inter-frame error represented by the feature amount is larger. Thus, it is represented that the driver D more easily pays attention to the region 42 as the value of the inter-frame error represented by the feature amount of the region 42 becomes larger and the frequency at which the value of the error is equal to or larger than the threshold is higher.

Thus, the attention state estimation module 30C estimates the attention state of the driver D of the vehicle 10 from the feature amount calculated by the feature amount calculation module 30B.

The attention state of the driver D represents the degree of inappropriateness of the driver D for driving which degree is represented by the feature amount of the region 42. For example, the attention state is represented by a numerical value representing the degree of inappropriateness.

Specifically, in a case where the one region 42 is included in the photographed images 40, the attention state estimation module 30C estimates the attention state indicating that the degree of inappropriateness is higher from a viewpoint that attention is more easily attracted as the value of the feature amount of the region 42 in the photographed images 40 in one frame is larger, the degree of inappropriateness becomes lower as the value of the feature amount is smaller, and the degree of inappropriateness is high from a viewpoint that overlooking is more likely when the value of the feature amount is too small.

Furthermore, in a case where the one region 42 is included in the photographed images 40, the attention state estimation module 30C may estimate, for the plurality of photographed images 40 continuous in time series, the attention state indicating that the degree of inappropriateness is higher as time in which a state in which the value of the feature amount of the included region 42 is equal to or larger than the threshold is continuous for predetermined time or longer is longer. In addition, the attention state estimation module 30C may use the predetermined number of frames instead of the predetermined time.

Furthermore, in a case where the one region 42 is included in the photographed images 40, the attention state estimation module 30C may estimate, for the plurality of photographed images 40 continuous in time series, the attention state indicating that the degree of inappropriateness is higher as the state in which the value of the feature amount of the included region 42 is equal to or larger than the threshold is generated at a predetermined frequency (predetermined number of frames) or more within a predetermined period.

Furthermore, in a case where there are the two regions 42 included in the photographed images 40, the attention state estimation module 30C estimates the attention state indicating that the degree of inappropriateness is higher as the difference between the feature amounts of the two regions 42 in the photographed images 40 in one frame is larger.

Furthermore, in a case where the two regions 42 are included in the photographed images 40, the attention state estimation module 30C may estimate, for the plurality of photographed images 40 continuous in time series, the attention state indicating that the degree of inappropriateness is higher as time in which the state in which the difference between the feature amounts of the included two regions 42 is equal to or larger than the threshold is continuous for predetermined time or longer is longer.

Furthermore, in a case where the two regions 42 are included in the photographed images 40, the attention state estimation module 30C may estimate, for the plurality of photographed images 40 continuous in time series, the attention state indicating that the degree of inappropriateness is higher as the state in which the difference between the feature amounts of the two included regions 42 is equal to or larger than the threshold is generated at the predetermined frequency (number of frames) or more within the predetermined period.

Furthermore, in a case where the two regions 42 are included in the photographed images 40, the attention state estimation module 30C may estimate, for the plurality of photographed images 40 continuous in time series, the attention state indicating that the degree of inappropriateness is higher as time in which the state in which the feature amount of at least one of the included two regions 42 is equal to or larger than the threshold is continuous for predetermined time or longer is longer.

Furthermore, in a case where the two regions 42 are included in the photographed images 40, the attention state estimation module 30C may estimate, for the plurality of photographed images 40 continuous in time series, the attention state indicating that the degree of inappropriateness is higher as the state in which the feature amount of at least one of the two included regions 42 is equal to or larger than the threshold is generated at the predetermined frequency (number of frames) or more within the predetermined period.

Furthermore, in a case where the three or more regions 42 are included in the photographed images 40, the attention state estimation module 30C estimates the attention state indicating that the degree of inappropriateness is higher as a maximum value of differences in the feature amounts of the three regions 42 in the photographed images 40 in one frame is larger.

Furthermore, in a case where the three or more regions 42 are included in the photographed images 40, the attention state estimation module 30C may estimate the attention state indicating that the degree of inappropriateness is higher as time in which the state in which the maximum value of the differences in the feature amounts of the included three regions 42 is equal to or larger than the threshold is continuous for predetermined time or longer is longer in the plurality of photographed images 40 continuous in time series.

Furthermore, in a case where the three or more regions 42 are included in the photographed images 40, the attention state estimation module 30C may estimate the attention state indicating that the degree of inappropriateness is higher as the state in which the maximum value in the differences in the feature amounts of the three included regions 42 is equal to or larger than the threshold is generated at the predetermined frequency (number of frames) or more within the predetermined period in the plurality of photographed images 40 continuous in time series.

Furthermore, in a case where the three or more regions 42 are included in the photographed images 40, the attention state estimation module 30C may estimate the attention state indicating that the degree of inappropriateness is higher as time in which the state in which the feature amount of at least one region 42 in the three or more included regions 42 is equal to or larger than the threshold is continuous for predetermined time or longer is longer in the plurality of photographed images 40 continuous in time series.

Furthermore, in a case where the three or more regions 42 are included in the photographed images 40, the attention state estimation module 30C may estimate the attention state indicating that the degree of inappropriateness is higher as the state in which the feature amount of at least one region in the included three regions 42 is equal to or larger than the threshold is generated at the predetermined frequency (number of frames) or more within the predetermined period in the plurality of photographed images 40 continuous in time series.

The predetermined period, the predetermined number of frames, the frequency, the predetermined frequency, and the threshold may be determined in advance. In addition, the predetermined period, the predetermined number of frames, the frequency, the predetermined frequency, and the threshold may be appropriately changed according to an operation instruction or the like of the input unit 10B by the user.

The driving proficiency determination module 30D determines a driving proficiency of the driver D.

The driving proficiency determination module 30D may determine the driving proficiency of the driver D who drives the vehicle 10 by using a known method.

For example, the driving proficiency determination module 30D receives the driving proficiency of the driver D by receiving the operation instruction of the input unit 10B by the driver D at the time of getting on the vehicle 10, or the like. The driving proficiency determination module 30D stores the received driving proficiency in the memory 32. In this case, the driving proficiency determination module 30D determines the driving proficiency of the driver D by reading the driving proficiency stored in the memory 32.

In addition, the driving proficiency determination module 30D may acquire, from the internal sensor 10C, the ECU 10F, or the like, observation results used for determination of the driving proficiency such as accelerator work by the driver D, steering operation, and an image of the driver D which image is photographed by an in-vehicle camera, and determine the driving proficiency of the driver D by using a learning model or the like that outputs the driving proficiency from these observation results.

In addition, for example, on the basis of the observation results, the driving proficiency determination module 30D may determine that the driving proficiency is lower as the number of times of sudden steering and sudden braking is larger, and determine that the driving proficiency is higher as the number of times thereof is smaller.

The output control module 30E outputs output information of an output mode corresponding to the estimation result of the attention state to the output unit 10A.

Specifically, the output control module 30E outputs, to the output unit 10A, output information of an output mode of informing the driver D that the attention state is poor with a stronger stimulus or an output mode of further encouraging a guide to a normal state as the degree of inappropriateness represented by the attention state estimated by the attention state estimation module 30C is higher.

For example, the output control module 30E displays, on at least one of the display unit 10I or the HUD 10K, a display screen including an image of a color, a shape, and a size telling that the attention state is poor with the stronger stimulus as the degree of inappropriateness is higher. In addition, the output control module 30E controls the illumination unit 10J to light up in a color and a blinking pattern telling that the attention state is poor with the stronger stimulus as the degree of inappropriateness is higher. In addition, the output control module 30E outputs, from the speaker 10L, an audio telling that the attention state is poor with a larger volume and the stronger stimulus, and an audio for a longer period as the degree of inappropriateness is higher.

Note that the output control module 30E may output, to the more output units 10A among the center display 10Ia, the pillar display 10Ib, the mirror display 10Ic, the illumination unit 10J, the HUD 10K, and the speaker 10L, the output information of the output mode of indicating that the attention state is poor with the stronger stimulus or the output mode of further prompting the guide to the normal state as the degree of inappropriateness is higher.

Furthermore, for example, the output control module 30E outputs, to the output unit 10A, a character, an image, or an audio further prompting the guide to the normal state as the degree of inappropriateness represented by the attention state estimated by the attention state estimation module 30C is higher.

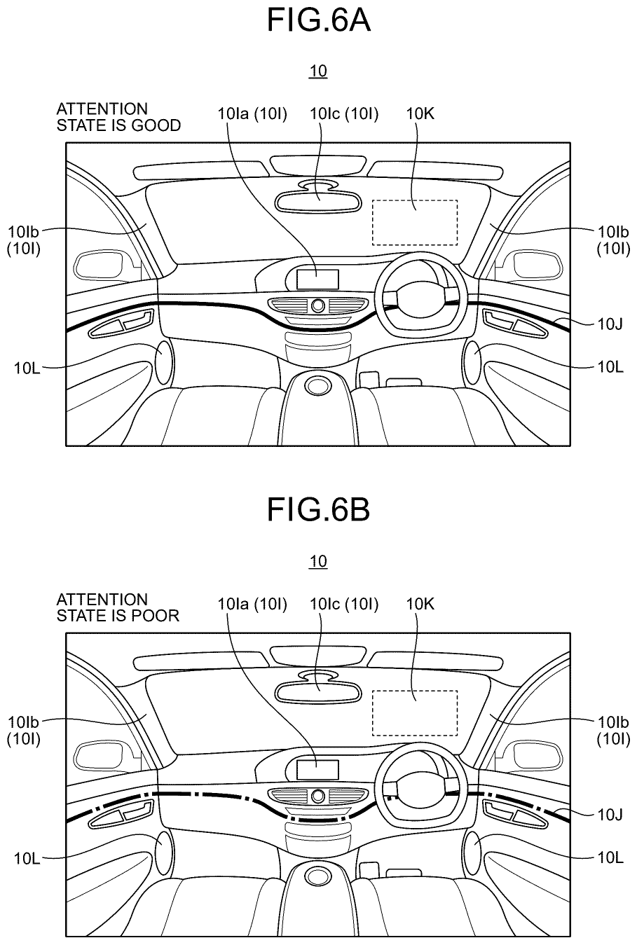

FIG. 6A is a diagram explaining an example of an output mode of when the degree of inappropriateness is small, that is, the attention state is good. FIG. 6B is a diagram explaining an example of an output mode of when the degree of inappropriateness is large, that is, the attention state is poor. As illustrated in FIG. 6A, in a case where the degree of inappropriateness is small and the attention state is good, for example, the output control module 30E causes the illumination unit 10J to emit light having a color that calls less attention, such as green. On the other hand, as illustrated in FIG. 6B, in a case where the degree of inappropriateness is high and the attention state is poor, the illumination unit 10J is caused to emit light having a color calling more attention, such as yellow in a blinking state that is a mode of calling more attention.

Thus, as the degree of inappropriateness represented by the attention state of the driver D is higher, it is possible to provide the output information in the output mode of informing the driver D that the attention state is poor with the stronger stimulus or the output mode of further prompting the guide to the normal state.

In addition, the output control module 30E may output the output information in an output mode corresponding to the attention state and the driving proficiency to the output unit 10A.

Specifically, to the output unit 10A, the output control module 30E may output the output information in an output mode with a strong stimulus that is noticeable even when the driver D does not actively check as the driving proficiency is lower, and may output the output information in an output mode with a weak stimulus that is not noticeable when the driver D does not actively check and that is noticeable when the driver D actively checks, as the driving proficiency is higher.

For example, in a case where the degree of inappropriateness represented by the attention state of the driver D is large and the driving proficiency is low, the output control module 30E outputs, to the larger number of output units 10A, the output information in the output mode of indicating that the attention state is poor or the output mode of prompting the guide to the normal state.

In addition, in a case where the degree of inappropriateness represented by the attention state of the driver D is large and the driving proficiency is high, the output control module 30E outputs, to the smaller number of (such as one) output units 10A, the output information in the output mode of indicating that the attention state is poor or the output mode of prompting the guide to the normal state.

In addition, in a case where the degree of inappropriateness represented by the attention state of the driver D is small and the driving proficiency is low, with respect to the larger number of output units 10A, the output control module 30E outputs, to the output units 10A, output information in an output mode of indicating that the attention state is good or an output mode of stopping the guide to the normal state.

In addition, in a case where the degree of inappropriateness represented by the attention state of the driver D is small and the driving proficiency is high, the output control module 30E outputs, to the smaller number of (such as one) output units 10A, the output information in the output mode of indicating that the attention state is good or the output mode of stopping the guide to the normal state.

Thus, according to the driving proficiency, the output control module 30E can provide the output information in the output mode with the strong stimulus that is noticeable even when the check is not actively made as the driving proficiency is lower, and can prevent the driver D from overlooking. In addition, as the driving proficiency is higher, the output control module 30E can provide the output information in the output mode with a weak stimulus that is not noticeable when the check is not actively made and that is noticeable when the check is actively made, and can reduce a trouble of the driver D.

Next, an example of a flow of information processing executed by the driving assistance device 20 will be described.

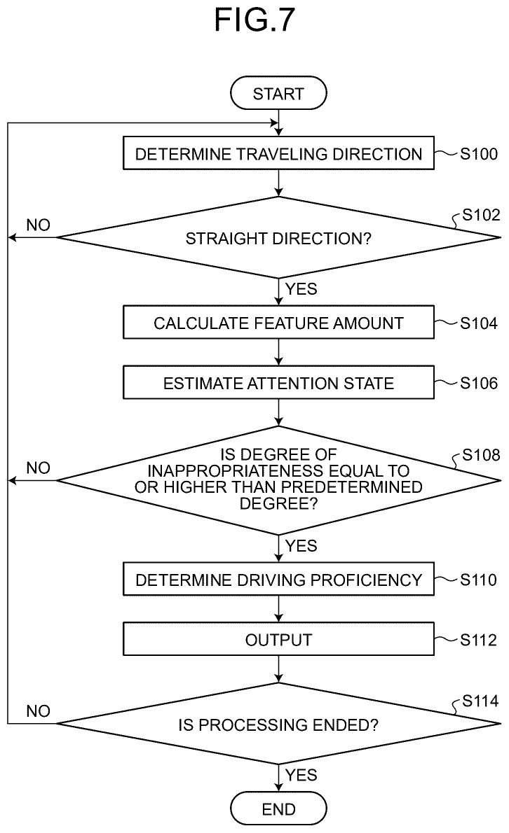

FIG. 7 is a flowchart illustrating an example of the flow of the information processing executed by the driving assistance device 20. In FIG. 7, the description will be made with a scene in which the predetermined direction is the straight direction and only a pair of the straight direction as the predetermined direction and information of the regions 42 corresponding to the straight direction is associated with each other and stored in the memory 32 being assumed.

The traveling direction determination module 30A determines the traveling direction of the vehicle 10 (Step S100). For example, the traveling direction determination module 30A determines the traveling direction of the vehicle 10 by acquiring the traveling direction of the vehicle 10 observed by the internal sensor 10C. In addition, the traveling direction determination module 30A may determine the traveling direction of the vehicle 10 on the basis of an observation result of a steering angle which result is included in the internal sensor 10C. In addition, the traveling direction determination module 30A may determine the traveling direction by acquiring the traveling direction of the vehicle 10 from the ECU 10F that controls the vehicle 10.

The traveling direction determination module 30A determines whether the traveling direction of the vehicle 10 which direction is determined in Step S100 is the straight direction (Step S102). When negative determination is made in Step S102 (Step S102: No), the processing returns to Step S100. When affirmative determination is made in Step S102 (Step S102: Yes), the processing proceeds to Step S104.

In Step S104, with respect to the regions 42 that correspond to the straight direction determined in Step S102 and that are included in the photographed images 40 in the straight direction of the vehicle 10 which images are photographed by the photographing unit 10D, the feature amount calculation module 30B calculates the feature amounts of the regions 42 (Step S104). Specifically, the feature amount calculation module 30B calculates the feature amount of each of the region 42A and the region 42B that are included in the photographed images 40 in the straight direction illustrated in FIG. 5 and that correspond to the straight direction that is the direction that coincides with the photographing direction of the photographed images 40.

The attention state estimation module 30C estimates the attention state of the driver D of the vehicle 10 from the feature amount calculated in Step S104 (Step S106). The attention state estimation module 30C estimates the attention state representing the degree of inappropriateness of the driver D for driving by using the feature amount of each of the region 42A and the region 42B which amount is calculated in Step S104.

The attention state estimation module 30C determines whether the degree of inappropriateness represented by the attention state estimated in Step S106 is a predetermined degree or higher (Step S108). This predetermined degree may be determined in advance. Furthermore, this predetermined degree may be appropriately changed according to the operation instruction or the like of the input unit 10B by the user.

In a case where the degree of inappropriateness is less than the predetermined degree (Step S108: No), the processing returns to Step S100 described above. In a case where the degree of inappropriateness is the predetermined degree or more, affirmative determination is made in Step S108 (Step S108: Yes), and the processing proceeds to Step S110.

In Step S110, the driving proficiency determination module 30D determines the driving proficiency of the driver D (Step S110).

The output control module 30E outputs output information of an output mode corresponding to the estimation result of the attention state estimated in Step S106 and the driving proficiency determined in Step S110 to the output unit 10A (Step S112).

Then, the processor 30 determines whether to end the processing (Step S114). For example, the processor 30 determines whether an instruction signal for instructing to turn off the engine of the vehicle 10 has been received from the ECU 10F or the like by operation on an ignition switch or the like of the vehicle 10 by the driver D, and makes the determination in Step S114. When negative determination is made in Step S114 (Step S114: No), the processing returns to Step S100. When affirmative determination is made in Step S114 (Step S114: Yes), this routine is ended.

As described above, the driving assistance device 20 of the present embodiment includes the traveling direction determination module 30A, the feature amount calculation module 30B, and the attention state estimation module 30C. The traveling direction determination module 30A determines whether the traveling direction of the vehicle 10 is the predetermined direction. The feature amount calculation module 30B calculates the feature amount of the predetermined region 42 which is included in the photographed images 40 in the predetermined direction of the vehicle 10 and in which the frequency at which the feature amount becomes equal to or larger than the threshold is equal to or higher than the predetermined frequency when the traveling direction of the vehicle 10 is the predetermined direction. The attention state estimation module 30C estimates the attention state of the driver D of the vehicle 10 from the feature amount.

Here, as the related art, a system of determining the attention state of the driver D according to the correlation between the high salient region included in the photographed front-side image 40 of the vehicle 10 and amplitude of a saccade of the driver D is disclosed. However, the high salient region included in the photographed front-side image during driving tends to concentrate on the vanishing point P to which the line of sight of the driver in the field of view of the driver D during driving is naturally guided and a neighboring region of the vanishing point P which region includes the vanishing point P. Thus, there is a problem that estimation accuracy is low in estimation of the attention state using the salient region. That is, in the related art, there is a case where the estimation accuracy of the attention state of the driver decreases.

On the other hand, in a case where the vehicle 10 is traveling with the predetermined direction such as the straight direction as the traveling direction, the driving assistance device 20 of the present embodiment estimates the attention state of the driver D by using the feature amount of the region 42 included in the photographed images 40 in the predetermined direction. The region 42 is the predetermined region which is included in the photographed images 40 in the predetermined direction and in which the frequency at which the feature amount becomes equal to or larger than the threshold is equal to or higher than the predetermined frequency when the traveling direction of the vehicle 10 is the predetermined direction.

As described above, the driving assistance device 20 of the present embodiment estimates the attention state of the driver D by using the feature amount of the region 42 that is a region which is included in the photographed images 40 in the predetermined direction at the time of traveling in the predetermined direction and to which the line of sight is directed more frequently as the attention state of the driver D is lower, and that is a region in which the possibility that the driver D unconsciously biases the attention at a point other than the vanishing point P at the time of traveling and causes the cognitive error is high.

Thus, the driving assistance device 20 of the present embodiment can estimate the attention state of the driver D with high accuracy by estimating the attention state by using the feature amount of the region 42 that corresponds to the predetermined direction and is included in the photographed images 40 in the predetermined direction at the time of traveling in the predetermined direction.

Thus, the driving assistance device 20 of the present embodiment can improve the estimation accuracy of the attention state of the driver D.

Note that the program of executing the information processing in the above-described embodiment has a module configuration including each of the above functional units. As actual hardware, for example, a CPU (processor circuit) reads the information processing program from the ROM or the HDD and performs execution thereof, whereby each of the above-described functional units is loaded onto the RAM (main storage), and each of the above-described functional units is generated on the RAM (main storage). Note that a part or all of the functional units described above can also be realized by utilization of dedicated hardware such as an application specific integrated circuit (ASIC) or a field-programmable gate array (FPGA).

According to the driving assistance device, the driving assistance method, and the driving assistance system according to the present disclosure, it is possible to improve the estimation accuracy of the attention state of the driver.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Note that the present technology can also have the following configurations.
(1) A driving assistance device includes:
   a processor; and
   a memory having instructions that, when executed by the processor, cause the processor to perform operations including:
      determining whether a traveling direction of a vehicle is a predetermined direction;
      calculating a feature amount of a predetermined region which is included in each of photographed images in the predetermined direction of the vehicle and in which a frequency at which the feature amount is equal to or larger than a threshold is equal to or higher than a predetermined frequency when the traveling direction of the vehicle is the predetermined direction; and
      estimating an attention state of a driver of the vehicle from the feature amount.
(2) In the driving assistance device according to (1), the feature amount includes a prediction error, an inter-frame error, a variance of the prediction error, a differential of the prediction error, a variance of the inter-frame error, or a differential of the inter-frame error.
(3) In the driving assistance device according to (1) or (2), the predetermined direction includes a straight direction, and the region includes a region which is included in each of the photographed images continuous in time series and in which the frequency at which the feature amount is equal to or larger than the threshold is equal to or higher than the predetermined frequency during traveling in the straight direction.
(4) In the driving assistance device according to any one of (1) to (3), the processor, in operation, estimates the attention state representing a degree of inappropriateness of the driver for driving, the degree of inappropriateness being represented by the feature amount.
(5) In the driving assistance device according to any one of (1) to (4), the processor, in operation, outputs output information in an output mode corresponding to an estimation result of the attention state.
(6) In the driving assistance device according to (5), the processor, in operation, outputs the output information in an output mode of indicating that the attention state is poor with a stronger stimulus or an output mode of further prompting a guide to a normal state as a degree of inappropriateness represented by the attention state is higher.
(7) In the driving assistance device according to (5) or (6), the processor, in operation, determines a driving proficiency of the driver, and outputs the output information in an output mode corresponding to the attention state and the driving proficiency.
(8) In the driving assistance device according to (7), the processor, in operation, outputs the output information in an output mode with a strong stimulus that is noticeable even when a check is not made actively as the driving proficiency is lower, and outputs the output information in an output mode with a weak stimulus that is not noticeable when the check is not actively made and that is noticeable when the check is actively made, as the driving proficiency is higher.
(9) A driving assistance method, executed by a driving assistance device, includes:
   determining whether a traveling direction of a vehicle is a predetermined direction;
   calculating a feature amount of a predetermined region which is included in each of photographed images in the predetermined direction of the vehicle and in which a frequency at which the feature amount is equal to or larger than a threshold is equal to or higher than a predetermined frequency when the traveling direction of the vehicle is the predetermined direction; and
   estimating an attention state of a driver of the vehicle from the feature amount.
(10) A driving assistance system includes:
   a processor; and
   a memory having instructions that, when executed by the processor, cause the processor to perform operations comprising:
      determining whether a traveling direction of a vehicle is a predetermined direction;
      calculating a feature amount of a predetermined region which is included in each of photographed images in the predetermined direction of the vehicle and in which a frequency at which the feature amount is equal to or larger than a threshold is equal to or higher than a predetermined frequency when the traveling direction of the vehicle is the predetermined direction; and
      estimating an attention state of a driver of the vehicle from the feature amount.

What is claimed is:

1. A driving assistance device comprising:
a processor; and
a memory having instructions that, when executed by the processor, cause the processor to perform operations comprising:
determining whether a traveling direction of a vehicle is a predetermined direction;
calculating a feature amount of a predetermined region which is included in each of photographed images in the predetermined direction of the vehicle and in which a frequency at which the feature amount is equal to or larger than a threshold is equal to or higher than a predetermined frequency when the traveling direction of the vehicle is the predetermined direction; and
estimating an attention state of a driver of the vehicle from the feature amount.

2. The driving assistance device according to claim 1, wherein
the feature amount includes a prediction error, an inter-frame error, a variance of the prediction error, a differential of the prediction error, a variance of the inter-frame error, or a differential of the inter-frame error.

3. The driving assistance device according to claim 1, wherein
the predetermined direction includes a straight direction, and
the region includes a region which is included in each of the photographed images continuous in time series and in which the frequency at which the feature amount is equal to or larger than the threshold is equal to or higher than the predetermined frequency during traveling in the straight direction.

4. The driving assistance device according to claim 2, wherein
the predetermined direction includes a straight direction, and
the region includes a region which is included in each of the photographed images continuous in time series and in which the frequency at which the feature amount is equal to or larger than the threshold is equal to or higher than the predetermined frequency during traveling in the straight direction.

5. The driving assistance device according to claim 1, wherein
the processor, in operation, estimates the attention state representing a degree of inappropriateness of the driver for driving, the degree of inappropriateness being represented by the feature amount.

6. The driving assistance device according to claim 2, wherein
the processor, in operation, estimates the attention state representing a degree of inappropriateness of the driver for driving, the degree of inappropriateness being represented by the feature amount.

7. The driving assistance device according to claim 3, wherein
the processor, in operation, estimates the attention state representing a degree of inappropriateness of the driver for driving, the degree of inappropriateness being represented by the feature amount.

8. The driving assistance device according to claim 4, wherein
the processor, in operation, estimates the attention state representing a degree of inappropriateness of the driver for driving, the degree of inappropriateness being represented by the feature amount.

9. The driving assistance device according to claim 1, wherein
the processor, in operation, outputs output information in an output mode corresponding to an estimation result of the attention state.

10. The driving assistance device according to claim 2, wherein
the processor, in operation, outputs output information in an output mode corresponding to an estimation result of the attention state.

11. The driving assistance device according to claim 3, wherein
the processor, in operation, outputs output information in an output mode corresponding to an estimation result of the attention state.

12. The driving assistance device according to claim 4, wherein
the processor, in operation, outputs output information in an output mode corresponding to an estimation result of the attention state.

13. The driving assistance device according to claim 9, wherein
the processor, in operation, outputs the output information in an output mode of indicating that the attention state is poor with a stronger stimulus or an output mode of further prompting a guide to a normal state as a degree of inappropriateness represented by the attention state is higher.

14. The driving assistance device according to claim 9, wherein
the processor, in operation,
determines a driving proficiency of the driver, and
outputs the output information in an output mode corresponding to the attention state and the driving proficiency.

15. The driving assistance device according to claim 13, wherein
the processor, in operation,
determines a driving proficiency of the driver, and
outputs the output information in an output mode corresponding to the attention state and the driving proficiency.

16. The driving assistance device according to claim 14, wherein
the processor, in operation,
outputs the output information in an output mode with a strong stimulus that is noticeable even when a check is not made actively as the driving proficiency is lower, and
outputs the output information in an output mode with a weak stimulus that is not noticeable when the check is not actively made and that is noticeable when the check is actively made, as the driving proficiency is higher.

17. The driving assistance device according to claim 15, wherein
the processor, in operation,
outputs the output information in an output mode with a strong stimulus that is noticeable even when a check is not made actively as the driving proficiency is lower, and
outputs the output information in an output mode with a weak stimulus that is not noticeable when the check is not actively made and that is noticeable when the check is actively made, as the driving proficiency is higher.

18. A driving assistance method executed by a driving assistance device, the method comprising:
determining whether a traveling direction of a vehicle is a predetermined direction;
calculating a feature amount of a predetermined region which is included in each of photographed images in the predetermined direction of the vehicle and in which a frequency at which the feature amount is equal to or larger than a threshold is equal to or higher than a predetermined frequency when the traveling direction of the vehicle is the predetermined direction; and
estimating an attention state of a driver of the vehicle from the feature amount.

19. A driving assistance system comprising:
a processor; and
a memory having instructions that, when executed by the processor, cause the processor to perform operations comprising:
determining whether a traveling direction of a vehicle is a predetermined direction;
calculating a feature amount of a predetermined region which is included in each of photographed images in the predetermined direction of the vehicle and in which a frequency at which the feature amount is equal to or larger than a threshold is equal to or higher than a predetermined frequency when the traveling direction of the vehicle is the predetermined direction; and
estimating an attention state of a driver of the vehicle from the feature amount.
